(19) United States
(12) Patent Application Publication
(10) Pub. No.: US 2010/0043079 A1
(43) Pub. Date: Feb. 18, 2010

(54) CODE SECURING FOR A PERSONAL ENTITY

(75) Inventors: Christian Barre, Betton (FR); Jean-Pierre Le Rouzic, Rennes (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 12/440,021

(22) PCT Filed: Sep. 5, 2007
(86) PCT No.: PCT/FR07/51874

§ 371 Date: Mar. 5, 2009

(30) Foreign Application Priority Data
Sep. 7, 2006 (FR) 06 53620

(51) Int. Cl. H04L 9/32; G06F 21/00

(52) U.S. Cl. 726/28

(57) ABSTRACT

A system secures a personal code for a user of a personal entity containing data and associated with a code processing entity. The personal entity establishes a graphical representation of characters that may be modified for each data request. The representation is associated with first coordinates of characters of the personal code and transmitted to the code processing entity. The code processing entity displays the representation so that the user selects therefrom characters representative of the personal code, determines second coordinates of selected characters and transmits the second coordinates to the personal entity. The personal entity compares the first and second coordinates so as to transmit requested data if said coordinates match.

The present invention relates to securing a personal code for a personal entity, such as a chip card. The code is also called PIN code (“Personal Identity Number”) often entered for an electronic transaction, the identification of a user, a non-repudiation or a digital right management DRM.

The invention more generally relates to securing any personal code such as a pass word to be entered in a non secured environment.

The secured formal identification of a user for example during an electronic transaction between two terminals in a telecommunications network can required a chip card belonging to the user and including secret data. The card is inserted into a card reader of one of the terminals. The secret data consisting in a unique personal code, referred to as a PIN code, are entered by the user on a man-machine interface of the terminal.

When the chip card is stolen or lost, the PIN code has the advantage of being only known to the card user and any third party can thus not use it. However, computer viruses being active in terminals are designed so as to detect the PIN code entered by the user, for example, and thus transmit it to another electronic entity or to use it in order to directly access to the secret data of the card.

In order to overcome such a disadvantage, it has already been suggested during the manufacture or the marketing of the card, to pre-record several different PIN codes in the card, each code being stored for a single use. A list of such codes is sent to the card user as a confidential post. However the limited number of PIN codes restricts the number of uses of the card. Moreover, a high number of pre-stored PIN codes is difficult to memorize by the card user. When the list of such codes is lost or stolen, the use of the card becomes obsolete.

It is also well known to write a unique confidential code on one of the sides of the chip card and to have it entered by the card user during an electronic transaction, for example, an on-line shopping transaction with no use of the chip card. Such a code imposed by the card manufacturer and known to the card supplier, for example, a bank, prevents a hacker, who does not possess any chip card, from creating a false card number and from initiating on-line secured transactions, as the latter require the entry of the code written on the card.

Currently, in order to securely enter the PIN code of a chip card, a terminal should be connected to an external device such as a keyboard having the transactions between the terminal and the device limited in order to avoid any contamination from a virus in the device. Such a solution is little ergonomical and very expensive.

In order to overcome the above mentioned disadvantages, a method for securing a user personal code giving access to data included into a personal entity, is characterized in that it comprises:

establishing and displaying a graphical representation including characters representative of the personal code and associated with at least one order,

selecting said characters by the user upon the displayed graphical representation as a function of said at least one order,

comparing first coordinates associated with the characters selected by the user with second coordinates of characters representative of the personal code associated with the graphical representation, and

transmitting data if the first and the second coordinates match.

The invention secures the personal code of a user for authorizing the access to data included in the personal entity, such as a chip card, after establishing a graphical representation of characters being displayed in a code processing entity, such as a terminal, the representation including characters representative of the personal code. The user selects characters that are representative of the personal code in the displayed graphical representation and that can not be predicted by a hacker while keeping an eye on the selected characters so as to infer from them a repetitive behavior of the user.

According to a feature of the invention, the method comprises establishing the graphical representation of characters modified after a predetermined number of successive data requests.

For more security, the graphical representation can be modified at each data request to the personal entity; in other words, the graphical representation varies from one data request to the next one. For example, the graphical representation is modified by a modification of the layout of the characters. However, more generally, the graphical representation is modified after a predetermined number of successive data requests, the predetermined number being equal to or more than 1. For example, the predetermined number is less than six. A computer virus active in the code processing entity can then not infer the personal code from codes entered by the user.

According to a first embodiment of the invention, the graphical representation is a table having a predetermined number of boxes, some of which are respectively associated with alphanumeric characters including the characters of the personal code and are randomly arranged in the table.

According to a second embodiment of the invention, the graphical representation is associated with at least one order, so that the user selects therein the characters of the personal code as a function of said at least one order. The orders can be modified after the predetermined number of successive data requests. The graphical representation can comprise a plurality of distinct character sets, one of which is to be selected depending on the orders so that the user selects therein the characters representative of the personal code. Alternatively, the graphical representation can then comprise a plurality of distinct character sets, at least two of which are to be selected depending on the orders so that the user selects therein the characters representative of the personal code.

The invention also relates to a method for securing a user personal code giving access to data included in a personal entity. The method is characterized in that it comprises:

establishing a graphical representation comprising characters representative of the personal code and associated with at least one order,

comparing first coordinates associated with characters representative of the personal code and selected by the user on the displayed graphical representation as a function of at least one order, with second coordinates of characters representative of the personal code associated with said graphical representation, and

transmitting data if the first and the second coordinates match.

According to a feature of the invention, the method comprises establishing the graphical representation of characters modified after a predetermined number of successive data requests. Alternatively, the graphical representation is modified by a modification of the layout of the characters.

According to embodiments of the method for securing a personal code, the graphical representation can be a table with a predetermined number of boxes, or be associated with orders and comprise a plurality of distinct character sets, as indicated hereinabove.

The invention is also related to a personal entity for securing a user personal code giving access to data included in the personal entity, characterized in that it comprises:

means (UE) for establishing a graphical representation (REPₙ) including characters (CR) representative of the personal code and associated with at least one order (CS1, CS2),

means for comparing first coordinates associated with characters representative of the personal code and selected by the user on the displayed graphical representation as a function of said at least one order, with second coordinates of characters representative of the personal code associated with said graphical representation, and

means for transmitting the data if the first and second coordinates match.

The personal entity comprises means for implementing the hereinabove described method.

The invention is also related to a computer program product downloadable from a communication network and/or stored on a computer readable medium and/or able to be executed by a processor. The program product comprises orders for implementing the following steps of:

establishing and displaying a graphical representation including characters representative of the personal code and associated with at least one order,

selecting said characters by the user on the graphical representation displayed as a function of said at least one order,

comparing first coordinates associated with the characters selected by the user with second coordinates of characters representative of the personal code associated with the graphical representation, and

transmitting data if the first and the second coordinates match.

The invention further relates to a code processing method for selecting by a user a personal code giving access to data included in a personal entity. The method is characterized in that it comprises the following steps of:

displaying a graphical representation comprising characters representative of the personal code and associated with at least one order,

selecting said characters by the user on the graphical representation displayed as a function of said at least one order,

determining first coordinates associated with the characters selected by the user, and

transmitting the first determined coordinates to the personal entity, so that the personal entity compares the first transmitted coordinates with second coordinates of characters representative of the personal code associated with the graphical representation and transmits the requested data if the first and second coordinates match.

According to the embodiments of the code processing method, the graphical representation can be modified by a modification of the layout of characters, or be a table having a predetermined number of boxes, or be associated with orders and comprise a plurality of distinct sets of characters, as indicated hereinabove.

Other features and advantages of the present invention will become more clearly apparent on reading the following description of embodiments of the invention given by way of nonlimiting example, with reference to the corresponding appended drawings, in which:

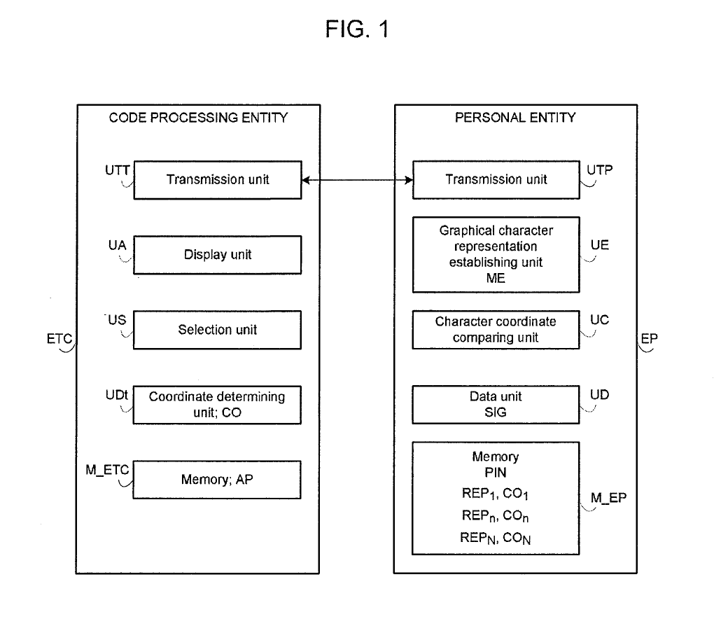

FIG. 1 is a schematic block diagram of a personal code securing system comprising a personal entity and a code processing entity;

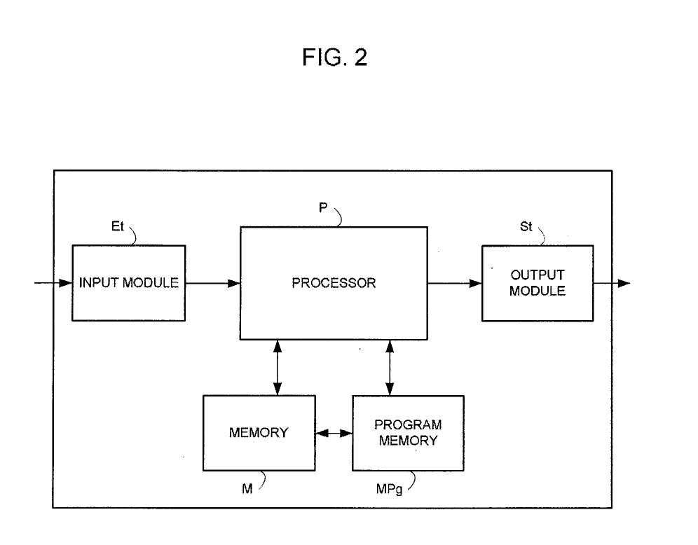

FIG. 2 is a block diagram representative of a material architecture for each entity of the system for securing a personal code according to the invention;

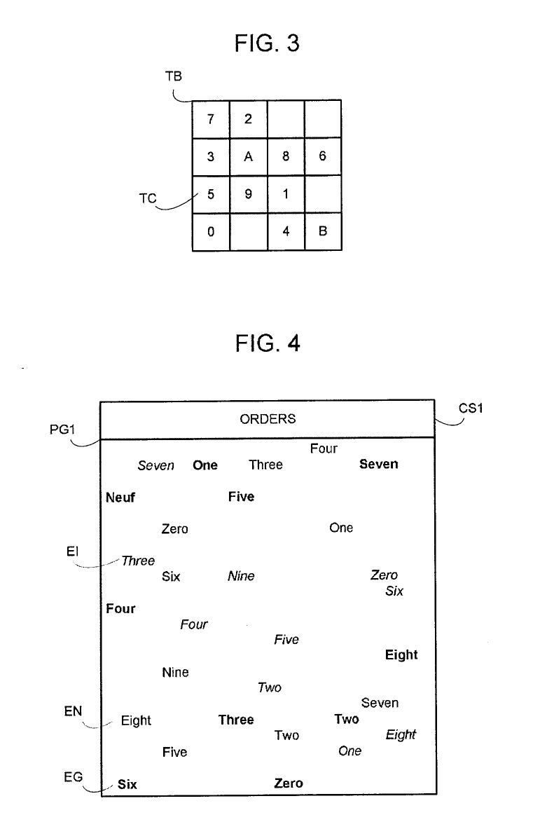

FIGS. 3, 4 and 5 are examples of a graphical representation of characters displayed according to the invention; and

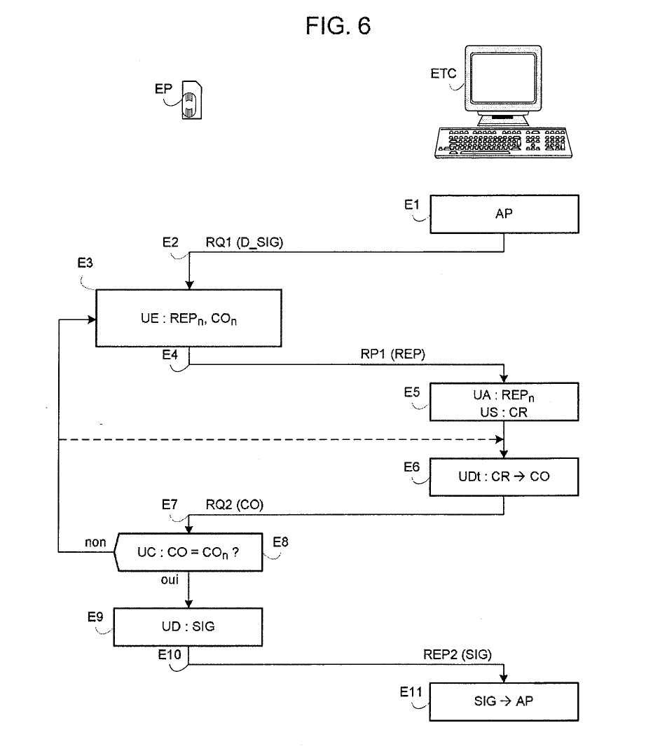

FIG. 6 is a flow chart of the method embodying the invention for securing a user personal code.

Referring to FIG. 1, a system for securing the personal code of a user of a personal entity, so-called PIN code (“Personal Identity Number”), comprises a personal entity EP, such as a chip card, associated with or without any contact with a code processing entity ETC, such as a terminal.

A client application AP in the code processing entity ETC is activated by the user of the personal entity EP associated with the code processing entity ETC and opens a communication channel with an external entity, referred to as a resource server, such as an on-line shopping server through a telecommunications network. In order for the user to be able to access via the application to secured resources of the server, the server requests the application to transmit data to it, such as a signature identifying the user. The signature is supplied by the personal entity EP of the user and is accessible after a selection of the PIN personal code of the user, for example on a keyboard connected to the code processing entity ETC.

In order to prevent any third party from detecting the user PIN personal code upon his selection, the invention establishes a random graphical representation, for example similar to a digital keyboard, and selection orders so that the user can entry his personal code from this graphical representation, the graphical representation being optionally different at each data request or being modified after a predetermined number of successive data requests, for example, ranging between two and five.

On FIG. 2, there is illustrated a material architecture for the personal entity EP and the code processing entity ETC. The architecture comprises a memory M, a processing unit equipped, for example, with a microprocessor P and driven by computer programs stored in a memory MPg implementing the methods according to the invention. An input module Et and an output module St such as communication interfaces are respectively arranged at the input and the output of the processing unit P.

In order to avoid any confusion between elements included in the architectures of the entities, each element of the architecture of an entity is referred to hereinunder in the description in combination with the reference designating the entity it belongs to. Thus, the personal entity EP comprises a processor P_EP, a memory M_EP, a program memory MPg_EP, an input module Et_EP and an output module St_EP. The code processing entity ETC comprises a processor P_ETC, a memory M_ETC, a program memory MPg_ETC, an input module Et_ETC and an output module St_ETC.

On FIG. 1, there are illustrated the code processing entity ETC and the personal entity EP in the form of functional blocks, most of which provide functions relating to the invention and can correspond to software and/or hardware modules.

The code processing entity ETC as a terminal comprises a transmission unit UTT, a display unit UA, a selection unit US and a coordinate determining unit UDt. Referring to FIG. 2, the transmission unit UTT encompasses modules Et_ETC and St_ETC and the coordinate determination unit UDt is memorized into the program memory MPg_ETC.

The memory M_ETC comprises, more particularly, a client application AP, such as an on-line shopping application.

The processing entity ETC may be a communicating personnel digital assistant PDA, a home terminal, either portable or not, such as a video game console or an intelligent television receiver cooperating with a display remote control or an alphanumeric keyboard also operating as a mouse through an infrared link.

Alternatively, the display unit UA and the selection unit US, on the one hand, and the determination unit UDt on the other hand, are respectively two distinct terminals, each of which possesses architecture similar to that shown in FIG. 2.

The personal entity EP as a chip card basically comprises a transmission unit UTP for exchanging messages with the transmission unit UTT of the code processing entity ETC, a unit UE for establishing a graphical representation of characters, a unit UC for comparing character coordinates and a data unit UD.

The memory M_EP is a non volatile memory, for example, an EEPROM or a Flash for memorizing particularly the PIN personal code only known to the card user.

According to an embodiment of the invention, the establishing unit UE comprises a mechanism ME for establishing a graphical representation REPₙ of a digital keyboard, each key of which comprises a set of pixels identified by digital coordinates, the index n ranging from 1 to an integer N, being preferably big. For example, the digital coordinates of each key of the keyboard on a two-dimension plane comprise an abscissa and an ordinate in a reference system on the screen of the display unit UA.

The graphical representation is transmitted and is displayable to the user in the code processing entity ETC and only is construable by the user and not directly by the processor P_ETC of the processing entity. One feature of the representation REPₙ is that it can be different, for example, upon each request for a personal code by the personal entity.

According to a first embodiment as illustrated on FIG. 3, the graphical representation REPₙ is a table TB with a predetermined number of boxes, some of which are similar to keyboard keys TC and associated respectively with alphanumeric characters. For example, the alphanumeric characters are ten digits and two letters, as shown in FIG. 3. The keys are randomly arranged in the table upon each display of the latter to the user, as a result of a request for secret data. The number of boxes of the table, for example equal to 16, is higher than or equal to the predetermined number of alphanumeric characters, digits, letters and/or symbols. The alphanumeric characters include at least the characters of the personal code that are selectable on the screen by the user, for example by means of a conventional keyboard or a processing unit mouse, or a touch screen.

According to a second embodiment as illustrated on FIG. 4, the graphical representation REPₙ nearly fills a screen page PG1 including several sets of alphanumeric characters, for example, in total three EN, EI and EG with different fonts: regular, italic and bold. The alphanumeric characters in the sets are arranged randomly in the screen page PG1 each time the latter is being displayed, as a result of a request for secret data. The alphanumeric characters of the sets EN, EI and EG include at least the characters of the personal code that can be selected on the screen by the user. The representation is associated with selection orders CS1 that can vary each time the graphical representation is displayed to the user, as a result of a request for secret data. The orders CS1 are, for example, “For entering and selecting your personal code, only consider the italic characters” and thus the set EI, or “For entering and selecting your personal code, only consider the bold characters” and hence the set EG, or “Entry your first and third italic characters, your second bold character and your fourth character in the regular font” for a four-character personal code.

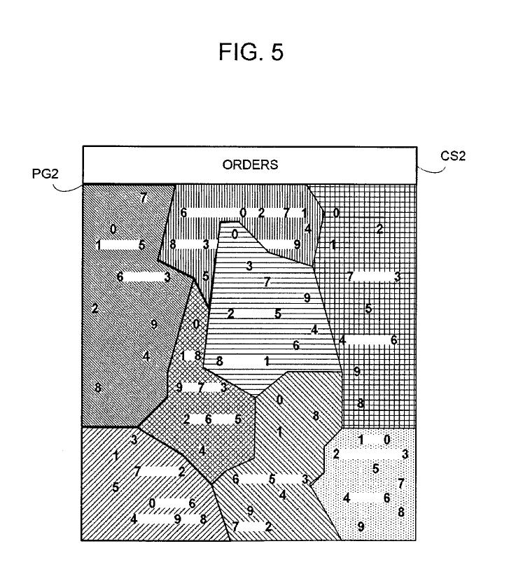

According to a third embodiment as shown in FIG. 5, the graphical representation REPₙ is a screen page PG2 including several distinct sets of alphanumeric characters respectively displayed in areas with different hatches and including at least the characters of the personal code that can be selected on the screen by the user. For example, the number of the sets is eight in, and each set includes predetermined alphanumeric characters, in such a case, 10 digits, as a result of a request for secret data. Some of the hatched sets with characters are to be selected depending on the selection orders CS2 so that the user selects characters representative of the personal code PIN in the selected sets. The selection orders CS2 that may vary each time the screen page PG2 is displayed to the user are for example:

“Please select your second digit in the horizontal hatched area, followed by your fourth digit in the area at left to the dashed hatched area. You should not select you first digit in an oblique hatched area. Select in the area above the dashed hatched area your third digit and finally, the last digit of your code in the area above the horizontal hatched area.”

Alternatively, and relative to the second and third embodiments, the orders can be transmitted orally or by means of a confidential post to the user.

Each graphical representation REPₙ established by the mechanism ME is associated in the card with the accurate coordinates COₙ of the keys to be selected successively matching with the stream of successive characters composing the PIN personal code of the user. For example, the accurate coordinates of the keys relating to a four-character personal code comprise four successive coordinate sets corresponding respectively to the four keys, the characters of which represent the four characters of the personal code.

According to an implementation of the establishing mechanism ME in the establishing unit UE, representations REP₁ to REPₙ are stored in the memory M_EP and are associated respectively with the accurate coordinates CO₁ to CO_{N} of keys to be selected being representative of the PIN personal code of the user. The mechanism ME randomly selects in the memory M_EP a representation REPₙ, for displaying the latter to the user in the processing entity ETC. The representation REPₙ selected by the mechanism ME is different from one display to the other.

Alternatively, the mechanism ME randomly generates a representation REPₙ to be displayed to the user in a processing entity ETC and randomly determines in such a representation the accurate coordinates COₙ representative of the PIN personal code of the user, for example, at the level of one digit per set of 10 digits for four sets of 10 digits randomly selected amongst eight sets according to FIG. 5.

The comparison unit UC compares first accurate coordinates COₙ associated with a graphical representation of characters established by the establishing unit UE at the second coordinates determined and transmitted by the processing entity and representative of the personal code that have been selected by the user depending on the graphical representation displayed by the processing entity. If the first and the second coordinates match, the access to the data of the data unit UD is authorized. The first and the second coordinates are matched via a logic relationship such as an addition of a coefficient or a multiplication by a coefficient. Alternatively, the first and second coordinates are identical.

The data unit UD checks, for example, an operation such as determining a signature SIG for authenticating the user of the entity EP or incrementing a counter, and comprises user personal data.

The personal entity EP can be a chip card included in a laptop or a mobile terminal, a payment card, an electronic purse card, an electronic health card, an electronic passport, or any microprocessor card associated with a fixed or mobile terminal. The personal entity EP can be any personal electronic device including data to which a personal code gives access.

Referring now to FIG. 6, securing the user personal code of the personal entity EP comprises steps E1 to E11.

In step E1, the user selects the client application AP of the processing entity ETC activated by the processor P_ETC so as, for example, to access to a resource secured in the resource server. The application AP opens a communication channel with the server via the transmission unit UTT of the processing entity and requests the access to the secured resource desired by the user in the resource server. For authenticating the user and authorizing him the access to the resource, the resource server requests the application AP to transmit him secret data such as a signature identifying the user.

In step E2, the application AP provides a request RQ1 including a signature request D_SIG to the personal entity EP via the transmission units UTT and UTP of the code processing entity ETC and the personal entity EP.

Upon receiving the request RQ1, in step E3, the processor P_EP activates the establishing unit UE that is to process the request D_SIG. The mechanism ME establishes a graphical representation REPₙ, for example according to a first embodiment, randomly selecting in the memory M_EP of the personal entity EP one REPₙ of the graphical representations REP₁ to REP_{N}, and the accurate associated coordinates COₙ of the keys to be selected by the user.

In step E4, further to a periodical interrogation of the processing entity ETC, the establishing unit produces a response RP1 including the representation REPₙ. The response RP1 is transmitted to the processing entity ETC via the transmission units UTP and UTT of the personal entity EP and the processing entity ETC.

The processor P_ETC of the processing entity puts in sleep mode the application AP and activates the display unit UA that processes the response RP1. In step E5, the display unit UA extracts from the response RP1 the representation REPₙ and displays the latter. The user selects through the selection unit US the keys of the displayed representation REPₙ the characters of which correspond to the characters CR of the personal code, respecting possible selection orders associated with the representation REPₙ and displayed, or transmitted orally or by means of a confidential post.

At each character CR of the personal code entered through the selection unit US on the representation REPₙ, the determining unit UDt activated by the processor P_ETC determines the coordinates representative of the key the active area of which has been selected. At the end of the selection, the determining unit contains coordinates CO representative of the set of coordinates of the keys corresponding to the characters of the PIN personal code of the user.

The determining unit UDt introduces the coordinates CO of the selected keys in a request RQ2 transmitted to the card, in step E7.

In step E8, the processor P_EP of the card activates in the card the comparing unit that extracts from the request the coordinates CO supplied by the processing entity and compares them with the accurate coordinates COₙ associated with the representation REPₙ. If the coordinates CO and COₙ match, the processor P_EP of the card activates the data unit UD in order to access to data, for example, determining a signature SIG, in step E9.

In step E10, the data unit UD produces and transmits a response RP2 including the determined signature SIG to the processing entity ETC. Upon receiving the response RP2 by the processing entity in step E11, the processor P_ETC of the processing entity ETC wakes the client application AP, and provides it with the signature SIG extracted from the response RP2. The application AP goes on with its processing, for example transmitting the signature SIG to the resource server.

If, in step E8, the coordinates CO and COₙ do not match, then the processor P_EP of the personal entity returns the method to step E3 in order to display the previous graphical representation or to establish another graphical representation to be transmitted to the processing entity ETC, depending on the predetermined number of successive data requests without modification of the graphical representation. Alternatively, the processor P_EP of the personal entity returns the method to step E6, as shown by a dashed line, so as to request the user, via the display unit UA, to select again the personal code. The number of returns can be limited.

Alternatively, if the coordinates CO and COₙ are different, then the processor P_EP of the card provides the processing entity ETC with a notification of the refusal of the personal code resulting in a refusal message being displayed.

The invention described here relates to a method, a personal entity EP such as a chip card and a code processing entity ETC such as a terminal associated with the personal entity. In an embodiment, the steps in the method of the invention are determined by instructions of computer programs incorporated respectively into the personal entity EP and into the processing entity ETC. The programs include program instructions which, when said programs are executed respectively in the personal entity and in the code processing entity, whose operation is then controlled by executing the programs, perform the steps in the method of the invention.

Consequently the invention also applies to computer programs adapted to implement the invention, including computer programs stored each on or in a storage medium readable by a computer and any data processing device. Such programs may be written in any programming language and take the form of source code, object code, or intermediate code between source code and object code, e.g. in a partially compiled form, or any other form suitable for implementing the method of the invention.

The storage medium may be any entity or device capable of storing the program. For example, the medium may comprise storage means on which the computer programs of the invention are stored, such as a ROM, for example a CD-ROM or a microelectronic circuit ROM, or USB key, or magnetic storage means, for example a diskette (floppy disk) or hard disk.

Furthermore, the storage medium may be a transmissible medium such as an electrical or optical signal, which may be routed via an electrical or optical cable, by radio or by other means. The programs of the invention may in particular be downloaded over an Internet type network.

Alternatively, the storage medium may be an integrated circuit into which the programs are incorporated, the circuit being adapted to execute the method of the invention or to be used in the execution of the method of the invention.

1. A method of securing a user personal code giving access to data included into a personal entity, said method comprising:
establishing and displaying a graphical representation including characters representative of said personal code and associated with at least one order,
selecting said characters upon the displayed graphical representation as a function of said at least one order,
comparing first coordinates associated with the selected characters with second coordinates of characters representative of the personal code associated with said graphical representation, and
transmitting data if said first coordinates and said second coordinates match.

2. The method according to claim 1, comprising modifying said graphical representation of characters after a predetermined number of successive data requests.

3. The method according to claim 1, wherein said graphical representation is modified by a modification of the layout of said characters.

4. The method according to claim 1, wherein said graphical representation is a table having a predetermined number of boxes, some of which are respectively associated with alphanumeric characters including said characters of said personal code and are randomly arranged in said table.

5. The method according to claim 1, wherein said graphical representation comprises a plurality of distinct character sets, one of which is to be selected depending on orders.

6. The method according to claim 1, wherein said graphical representation comprises a plurality of distinct character sets, at least two of which are to be selected depending on orders.

7. A personal entity for securing a personal code giving access to data included in the personal entity, said personal entity comprising:
means for establishing a graphical representation including characters representative of said personal code and associated with at least one order,
means for comparing first coordinates associated with characters representative of said personal code and selected on a displayed graphical representation as a function of said at least one order, with second coordinates relating to characters representative of said personal code and associated with said graphical representation, and
means for transmitting said data if said first coordinates and said second coordinates match.

8. A computer program product including code instructions which, when the program is executed by a processor, perform the steps of the method defined in claim 1.
